(19) United States
(12) Patent Application Publication
(10) Pub. No.: US 2014/0198368 A1
(43) Pub. Date: Jul. 17, 2014

(54) High Gain Display Screen with Rotated Microlens Array

(71) Applicants: MICROVISION, INC., Redmond, WA (US); KOC UNIVERSITY, Istanbul (TR)

(72) Inventors: Hakan Urey, Istanbul (TR); Mehmet Kivanc Hedili, Istanbul (TR); Joshua O. Miller, Woodinville, WA (US)

(73) Assignees: KOC UNIVERSITY, Istanbul (TR); MICROVISION, INC., Redmond, WA (US)

(21) Appl. No.: 13/743,836

(22) Filed: Jan. 17, 2013

(51) Int. Cl. G02B 26/08

(52) U.S. Cl. CPC G02B 26/0816
USPC 359/226.1; 359/619; 359/627

(57) ABSTRACT

A transparent screen includes a microlens array. The microlens array includes microlenses that are individually rotated to reflect a projected image to a common eyebox. The microlenses may have a dichroic coating to reflect narrowband light. An automotive windshield may include an embedded microlens array as part of a head up display. Eyewear includes an eyepiece with a rotated microlens array and a projector to project content on the microlens array.

### BACKGROUND

Invention of low power pico-projectors created a demand for high-gain screens that can function even under strong ambient light. Planar microlens array based (MLA) screens create displays with a certain gain but the technology is not scalable to larger screen sizes. As the eyebox size increases, the gain decreases for planar MLAs.

### BRIEF DESCRIPTION OF THE DRAWINGS

FIG. 1 shows the structure of a see-through rotated microlens array in accordance with various embodiments of the present invention;

FIG. 2 shows how the rotated microlenses expand and direct the incident light towards a user viewing location to create a fully overlapped eyebox in accordance with various embodiments of the present invention;

FIGS. 3 and 4 show head up displays that include screens with rotated MLAs in accordance with various embodiments of the present invention;

FIGS. 5 and 6 show vectors used for determining the rotation angles of individual microlenses in accordance with various embodiments of the present invention;

FIG. 7 shows a sample contour plot of rotation angles of lenses in a rotated microlens array in accordance with various embodiments of the present invention;

FIG. 8 shows a high gain transparent separator screen with an embedded rotated microlens array in accordance with various embodiments of the present invention;

FIG. 9 shows an example geometry of the transparent separator screen of

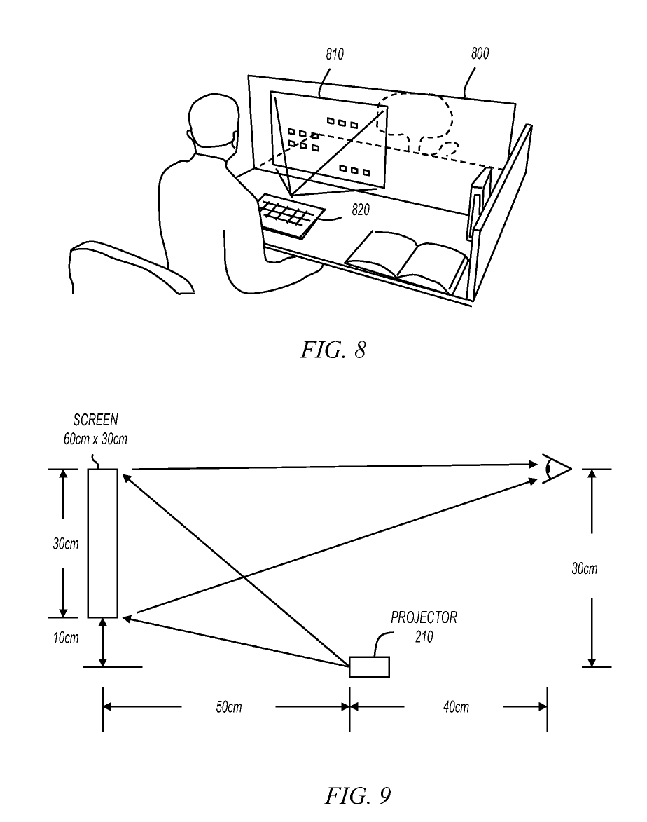

FIG. 8 in accordance with various embodiments of the present invention;

FIG. 10 shows a display screen including a rotated microlens array for multiple users in accordance with various embodiments of the present invention;

FIG. 11 shows an example lens packing for the rotated microlens array screen of FIG. 10 in accordance with various embodiments of the present invention; and

FIG. 12 shows a see-through eyewear display that includes a rotated microlens array in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Various embodiments of the invention provide a rotated microlens array screen and a design method that works for any given system geometry (positions of the screen, the user/users and the projector) where each microlens is rotated such that the incident light is reflected towards the user. As a result, eyeboxes corresponding to every pixel on the screen substantially overlap, thus the gain of the screen is improved. The rotated MLA screen provides not only a very bright display but also a privacy display, as all the light is concentrated in a limited eyebox that is set by the radius of curvature of the microlenses. Invention embodiments incorporating rotated MLA screen include, but are not limited to, head-up display screens, transparent separator screens for single or multiple users and head-mounted display screens.

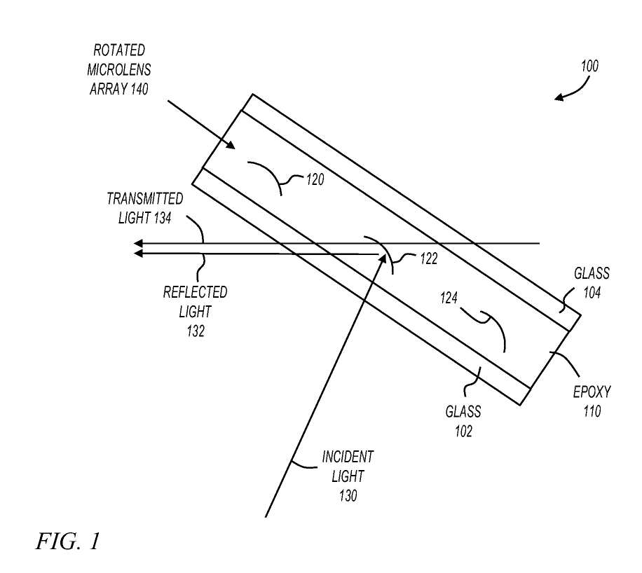

FIG. 1 shows the structure of a see-through rotated microlens array in accordance with various embodiments of the present invention. See-through screen 100 includes an embedded microlens array (MLA) 140 that in turn includes a plurality of convex or concave microlenses, which are partially or fully reflective. Microlenses 120, 122, and 124 are shown embedded in epoxy layer 110, which is sandwiched between glass layers 102 and 104. In some embodiments the glass layers and epoxy are transmissive, and the microlenses are at least partially reflective. For example, a dichroic coating may be applied to the microlenses to reflect narrowband incident light shown at 130 and to transmit broadband light shown at 134.

The microlenses in MLA 140 do not all have parallel optical axes, nor are they necessarily rotated by a common angle. For example, the microlenses within MLA 140 have varying surface normal angles such that incident light from a point source (e.g., a projector) is directed to an eyebox centered about a user's viewing location (e.g., viewer's eyes) from all positions across the field of view. Varying tilt angles of the microlenses provide an efficient relay and high brightness even with a low-lumen output projector.

Epoxy layer 110 is a see-through screen structure designed to substitute for the PVB (PolyVinyl Butyral) layer typically sandwiched between the two glass layers of a windshield to create safety glass. The see-through screen is a sandwich structure beginning with a molded MLA that has the desired form of rotated microlenses. Some embodiments include an epoxy casting as shown in FIG. 1, although other embodiments include polymer or plastic materials rather than epoxy. The MLA is then coated with a partially reflective thin coating. Either metal or dielectric partial-reflective coatings could be used depending on the desired properties of the screen. Finally, the coated surface is covered with another layer of the same material used under the coating layer so that the partially reflective coating is the only index mismatch in the full sandwich structure. The whole structure is buried between the layers of the screen. The transmitted light 134 beam does not experience any spatially varying phase and propagates through the glass without any changes to the wavefront. The reflected beam 132, on the other hand, is directed towards the user's viewing location and forms an expanded eyebox.

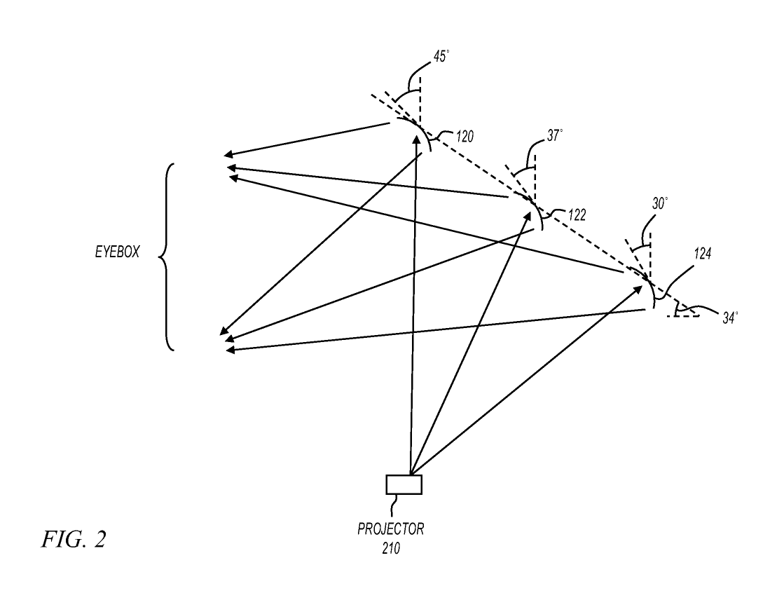

FIG. 2 shows how the rotated microlenses expand and direct the incident light towards a user viewing location to create a fully overlapped eyebox in accordance with various embodiments of the present invention. FIG. 2 shows the same three microlenses shown in FIG. 1, but omits the epoxy and glass layers to show that the rotated microlens array does not need to be buried in index matched epoxy layers if a 100% reflective screen is desired. It is important to note that the embedded MLA may include thousands of microlenses in a two dimensional array (three dimensional if the curvature of the screen is taken into account). Only three microlenses are shown in FIG. 2 for simplicity.

FIG. 2 also shows projector 210. The combination of projector 210 and screen 100 (FIG. 1) form a high gain, efficient display, which may be see-through or not depending on the reflective coating and screen structure used. Projector 210 may be any type of projector. For example, projector 210 may be a panel based projector based on a transmissive or reflective panel (liquid crystal on silicon, micromirror array) or may be a scanning laser projector. In operation, projector 210 projects content onto screen 100 and the content can be viewed from the eyebox created by the rotated MLA.

In a planar reflective MLA, in which all microlens optical axes are parallel, the central direction of the reflected light is governed by the usual Law of Reflection, i.e., angle of incidence equals angle of reflection, creating multiple off-axis eyeboxes. When viewing a planar reflective MLA, the full content on the screen can only be viewed from the overlapping region of all of the individual eyeboxes, which is smaller than the individual eyeboxes themselves. The light reflected from a planar MLA is not contained in a common overlapping eyebox.

As shown in FIG. 2, each microlens is rotated about at least one axis such that the reflected light is contained in a common overlapping eyebox, typically positioned at a user's eye. In various embodiments of the present invention, the MLA includes microlenses rotated about two axes, such that the incident beam is reflected towards the user's eyes. In other words, the pointing of the microlenses steers the light coming from the projector towards the eyes while the curvature of the microlenses expand the incident beam to create an eyebox. As a result, eyeboxes corresponding to every pixel on the screen overlap almost perfectly, so the available light is used more efficiently. This produces a useable eyebox where the individual pixel eyeboxes overlap, and because they overlap substantially completely, it effectively increases the screen gain, giving more brightness than the partially overlapped case achieved by a planar reflective MLA. Additionally, the tilting of each microlens, based on the specific geometry in a given application, compensates for the angle of the screen from the position of the projector and therefore provides greater freedom of where to position the projector.

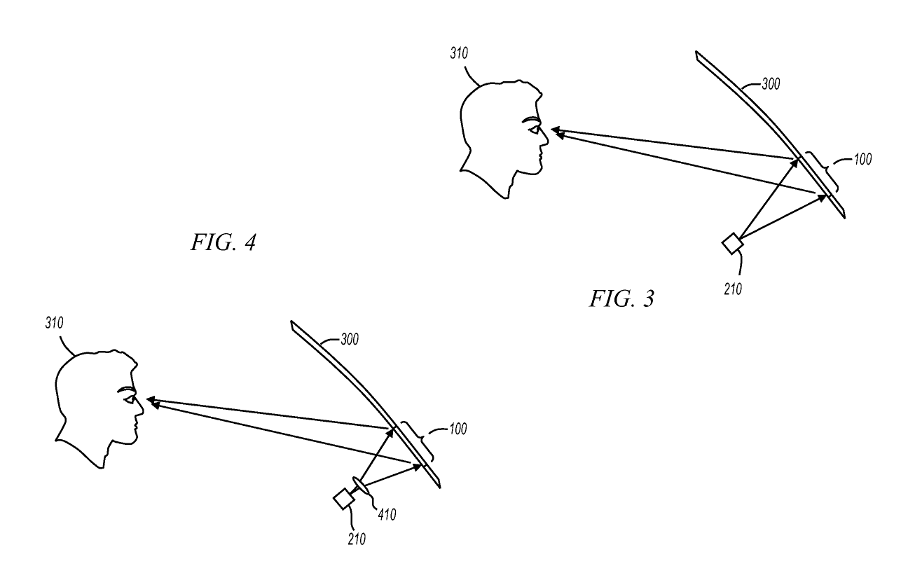

FIGS. 3 and 4 show head up displays that include screens with rotated MLAs in accordance with various embodiments of the present invention. FIG. 3 shows example positions of projector 210, windshield 300, screen 100 with rotated MLA and vehicle driver 310. In some embodiments projector 210 is embedded in a vehicle dashboard.

Since the rotation angles of the microlenses are dependent on the system geometry such as the positions of the driver 310, the screen 100 and the projector 210, the various embodiments of the invention have been designed to be suitable for a wide range of automobiles. For example, the embodiment shown in FIG. 3 assumes that the angle between the z-axis and the windshield is 34° (also shown in FIG. 2). The screen size is 175×87.5 mm and the height of the center of the screen is 81 mm from the dashboard. The driver is 1200 mm away from the bottom of the windshield and the eyes are 250 mm above the dashboard. The eyebox, which is centered on the driver's head, has a shape and size determined by the shape of the microlens' aperture and the radius of curvature, respectively. Some embodiments use rectangular microlenses to produce a rectangular shaped eyebox. Other embodiments use differently shaped microlenses. Some embodiments utilize a 3.2 mm radius of curvature for the microlenses to yield an eyebox size of about 30 cm×30 cm at the driver's position. As the rotated MLA has a faceted surface and it is used off-axis, one of the design challenges is to avoid the shadowing effect from adjacent microlenses that blocks the light coming from the microlens immediately below. In some embodiments, the microlenses are 150 μm tall, and the MLA pitch is kept 300 μm constant in both directions to avoid shadowing. In other words the MLA pitch is kept constant but the aperture size is varied. In some embodiments, the pitch is optimized using two constraints: (i) it should be smaller than the display pixels on the screen, and (ii) it should be large enough to keep the diffraction order spacing at the eye smaller than the minimum pupil size to avoid intensity variations as the eye moves within the eyebox. If we assume a broadband, partially reflective coating, a good first order estimate for the screen properties is governed by the relationship R+T+A=1, where R is reflectance, T is transmittance, and A is absorption. A single layer metal coating is the simplest. The amount of transmittance and reflectance varies with the thickness of the metal layer. In some embodiments, an 80 angstrom thick aluminum coating provides a screen with about 30% reflectance, but the metal layer also causes absorption, about 30% in this case, bringing the transmittance down to approximately 40%. With a broadband dielectric coating, absorption is avoided, so for 30% broadband reflectance, the transmittance is increased to approximately 70%.

In some embodiments, a notch coating (e.g., dichroic coating) is applied as the partially reflective layer. The notch coating may be designed to produce high reflectance at laser wavelengths used in a laser projector, and low reflectance for the rest of the visible spectrum. In this way, the efficiency of relaying the projected light to the driver's eyes can be increased while still maintaining a high average transmittance across the visible band. In these embodiments a dichroic coating is applied to reflect one or more of narrowband red, green, and blue light. This way, the windshield reflects narrowband light and transmits broadband light.

FIG. 4 shows the same system as FIG. 3, but also includes a lens 410 to allow for varied placement of projector 210. Although windshield 300 has been described as an automotive windshield, this is not a limitation of the present invention. For example, head-up displays incorporating screen 100 may be used in planes, trains, automobiles, or any other HUD application.

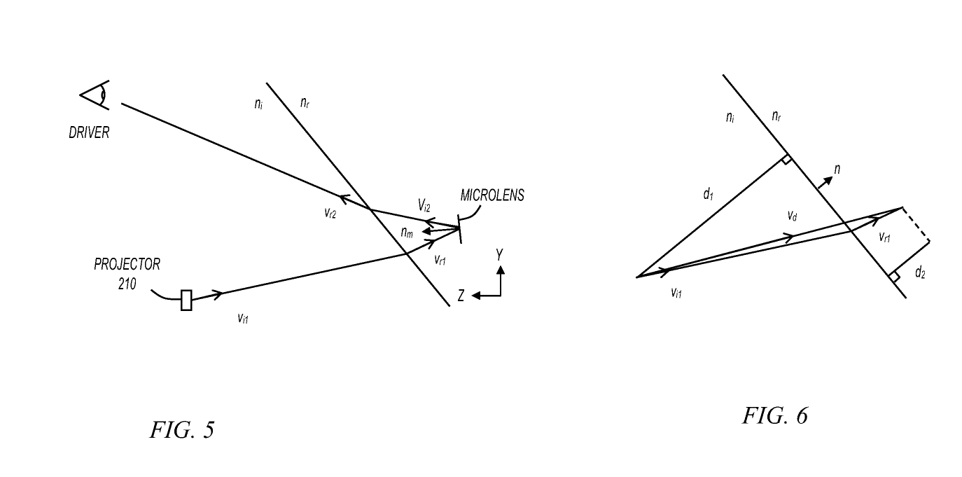

FIGS. 5 and 6 show vectors used for determining the rotation angles of individual microlenses in accordance with various embodiments of the present invention. Since the tilting of the microlenses is intended to center the individual pixel eyeboxes between the user's eyes, we begin by treating the microlenses as planar micro-mirrors. We then calculate their rotations about the x and y axes to steer the incoming light from the projector towards the user. Finally, we convert the rotated flat micro-mirrors into microlenses to expand the light to create the eyebox. The rotation angles are calculated based on the positions of the projector, the user, and the individual microlenses, using the method described below.

Since the microlenses are buried in an index-matched layer, the incident and reflected light are subject to refraction due to the refractive index difference between the cover glass and the surrounding air, as illustrated in FIG. 5. Thus, the problem of finding the aiming point on the interface to get the light crossing the desired point in the other medium must be included in the calculations. FIG. 6 illustrates the details of refraction at the glass interface. Equations below are used to calculate the vectors vᵢ₁ and vᵣ₁ to find the path from projector to micro-mirror. The path from the micro-mirror to the user's eye is calculated in a similar manner by applying the same set of equations to find vᵢ₂ and vᵣ₂ in FIG. 5.

Snell's Law in vector form is shown in Eq. 1, where n is the unit surface normal vector of the interface, η is the ratio of the refractive indices nᵢ/nᵣ, vᵢ₁ and vᵣ₁ are the unit vectors along the incident and refracted light respectively. As both the incident and refracted vectors are not known, a second equation is needed to obtain two equations with two unknowns. A weighted sum of vᵢ₁ and v ᵣ₁ should result in the desired vector v_{d}, which is the vector between the desired initial and final points, as illustrated in FIG. 6. The weights of the vectors should be selected as in Eq. 2, where d₁ and d₂ are the distances of the initial and final points to the interface plane and (vᵢ₁•n) and (vᵣ₁•n) are the dot products of the incident and refracted unit vectors with the interface surface normal, respectively. Eq. 3 is obtained by solving Eq. 1 and Eq. 2 together where (vᵢ₁•n) is the only independent unknown.

As the dot product is a scalar quantity, the incident vector vᵢ₁ is expressed as a single variable function of (vᵢ₁•n). We know that vᵢ₁ is a unit vector so its norm should be equal to one. To get the correct value of (vᵢ₁•n), f (x) in Eq. 4 is minimized iteratively using the Newton-Raphson method, where x denotes (vᵢ₁•n).

$$\begin{matrix}{v}_{r 1} = ( sign ( {v}_{i 1} \cdot n ) \sqrt{1 - {η}^{2} + {{η}^{2} ( {v}_{i 1} \cdot n )}^{2}} ( {v}_{i 1} \cdot n ) η ) n + η {v}_{i 1} & ( 1 ) \\ {v}_{d} = \frac{{d}_{1}}{{v}_{i 1} \cdot n} {v}_{i 1} + \frac{{d}_{2}}{{v}_{r 1} \cdot n} {v}_{r 1} & ( 2 ) \\ {v}_{i 1} = \frac{{v}_{d} - {d}_{2} ( 1 - \frac{η ( {v}_{i 1} \cdot n )}{\sqrt{1 - {η}^{2} + {{η}^{2} ( {v}_{i 1} \cdot n )}^{2}}} ) n}{\frac{d 1}{( {v}_{i 1} \cdot n )} + \frac{η {d}_{2}}{\sqrt{1 - {η}^{2} + {{η}^{2} ( {v}_{i 1} \cdot n )}^{2}}}} & ( 3 ) \\ f ( x ) = ‖ {v}_{i 1} ‖ - 1 & ( 4 )\end{matrix}$$

Once vᵢ₁ is obtained by plugging in the computed value of (vᵢ₁•n) in Eq. 3, vᵣ₁ can be calculated using Eq. 1. This procedure is followed two times for each micro-mirror for finding the unit incident and refracted vectors from the projector to the micro-mirror and from the micro-mirror to the user as shown in FIG. 5 as vᵢ₁, vᵣ₁, vᵢ₂, vᵣ₂, respectively. Surface normal of the micro-mirror should be calculated such that when vᵣ₁ is the incident unit vector, vᵢ₂ should be the reflected unit vector. Eq. 5 gives the reflected unit vector vᵢ₂, when a unit vector vᵣ₁ is incident on a surface with surface normal nₘ. In our case, we know the incident and reflected vectors and we need the surface normal vector. Using the fact that angle of incidence is equal to the angle of reflection, Eq. 5 can be transformed into Eq. 6, which gives the surface normal when incident and reflected vectors are known.

After we find the surface normal vector, the required rotation angles can be calculated by solving the rotation matrix shown in Eq. 7, where θ and φ are the rotations about the x and y axes, respectively. xₘ, yₘ, zₘ in Eq. 7 are the components of the vector nₘ. Unrotated micro-mirrors are assumed to have unit surface normal vectors parallel to the z-axis. (The coordinate axes are shown in FIG. 5)

$$\begin{matrix}{v}_{i 2} = {v}_{r 1} - 2 ( {v}_{r 1} \cdot {n}_{m} ) {n}_{m} & ( 5 ) \\ {n}_{m} = \frac{{v}_{r 1} - {v}_{i 2}}{\sqrt{2 ( 1 - ( {v}_{i 2} \cdot {v}_{r 1} ) )}} & ( 6 ) \\ [ \begin{matrix}cos ϕ & 0 & sin ϕ \\ sin ϕ sin θ & cos θ & - cos ϕsin θ \\ - sin ϕ cos θ & sin θ & cos ϕ cos θ\end{matrix} ] [ \begin{matrix}0 \\ 0 \\ 1\end{matrix} ] = [ \begin{matrix}{x}_{m} \\ {y}_{m} \\ {z}_{m}\end{matrix} ] & ( 7 ) \\ ϕ = {sin}^{- 1} ( {x}_{m} ) & ( 8 ) \\ θ = {tan}^{- 1} ( - \frac{{y}_{m}}{{z}_{m}} ) & ( 9 )\end{matrix}$$

Custom microlens array fabrication with varying tilts across a large area is challenging and generally more complex than a planar array. A master may be created from which copies may be mass produced. The master can be produced with high-precision diamond cutting or laser writing technologies. Once the master is made, replication is relatively straightforward using standard molding technologies.

Note that the design methodology introduced above is applicable for arbitrary placement of the projector, screen and for the desired eyebox position and size.

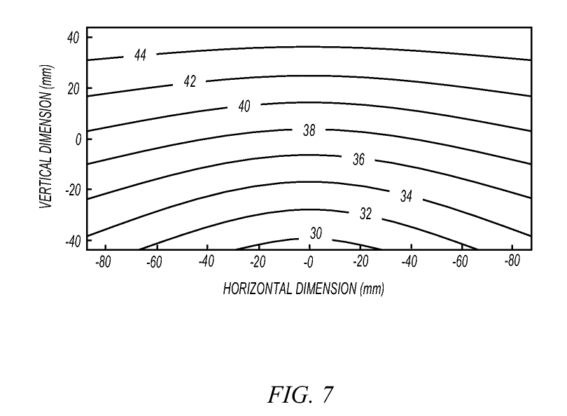

FIG. 7 shows a sample contour plot of rotation angles of lenses in a rotated microlens array in accordance with various embodiments of the present invention. Rotation angles for each micro-mirror in an MLA were calculated using the method described above. FIG. 7 shows the 2D contour plot of the magnitude of the compound rotation angles for the design described with reference to FIG. 3 as a function of micro-mirror position, that is, \sqrt{θ²+φ²}. The tilt direction shown in FIG. 7 is normal to the contour lines.

FIG. 8 shows a high gain transparent separator screen with an embedded rotated microlens array in accordance with various embodiments of the present invention. Transparent separator screen 800 is shown separating two desks in an office environment, although screen 800 may be used in any environment. A projector is embedded in device 820. Transparent separator screen 800 includes a rotated MLA at 810. In embodiments represented by FIG. 8, the MLA is used as a computer screen, although this is not a limitation of the present invention. For example, the rotated MLA 810 may be embedded within, or attached to, any medium such as a shop window.

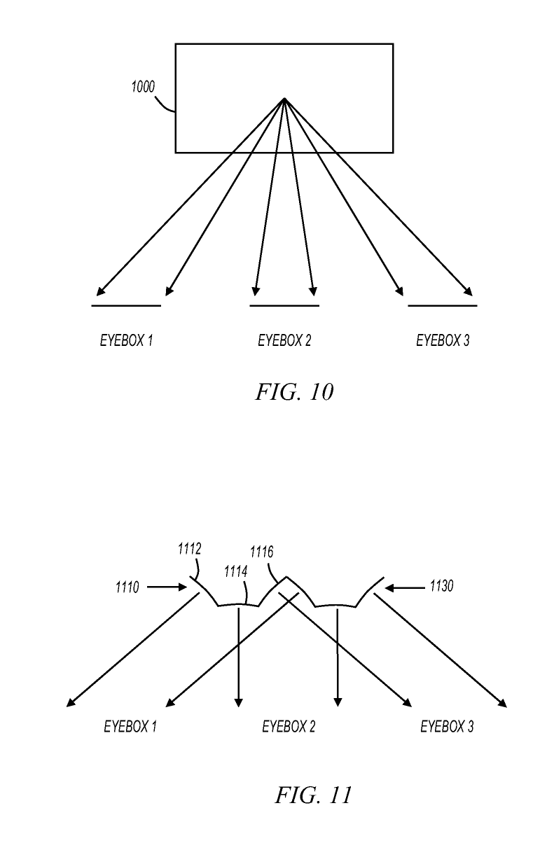

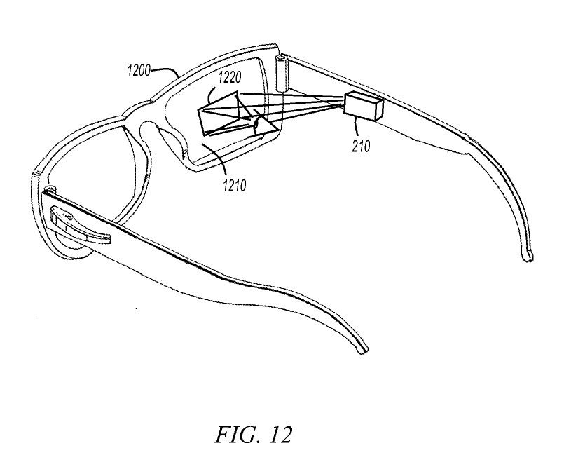

FIG. 9 shows an example geometry of the transparent separator screen of FIG. 8 in accordance with various embodiments of the present invention. The geometry shown in FIG. 9 may be used to determine the rotation angles for microlenses as described above with reference to FIGS. 5 and 6.

FIG. 10 shows a display screen including a rotated microlens array for multiple users in accordance with various embodiments of the present invention. Screen 1000 includes an array of rotated microlenses to produce three distinct eyeboxes, although this is not a limitation of the present invention. For example, any number of eyeboxes may be produced. In some embodiments, screen 1000 may be used in an office environment similar to that shown in FIG. 8 where multiple users may view different content. In other embodiments, screen 1000 may be used to project content on a shop window that provides different content to pedestrians as they walk by. Projected content may be segmented such that different segments are viewed in the different eyeboxes.

FIG. 11 shows an example lens packing for the rotated microlens array screen of FIG. 10 in accordance with various embodiments of the present invention. Two example microlens profiles 1110, 1130 are shown in FIG. 11. Each microlens includes a plurality of lenslets. For example, microlens 1110 includes lenslets 1112, 1114, and 1116. The orientation and rotation of each of the lenslets may be determined using the method described above with reference to FIGS. 5 and 6.

FIG. 12 shows a see-through eyewear display that includes a rotated microlens array in accordance with various embodiments of the present invention.

Eyewear 1200 includes eyepiece 1210, which in turn includes a see-through MLA 1220. Eyewear 1200 also includes projector 210. In operation, projector 210 projects an image onto MLA 1220, which is configured to reflect the image to the wearer's eye. The rotation of the individual microlenses in MLA 1220 may be determined using the geometry of the various components as described above with reference to FIGS. 5 and 6. Note that the user should wear a custom designed contact lens in order to see the content on the screen.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. An apparatus comprising.
a microlens array screen including a plurality of microlenses, each of the plurality of microlenses having an optical axis, wherein not all of the plurality of microlenses have parallel optical axes.

2. The apparatus of claim 1 further comprising two glass layers between which the microlens array is sandwiched.

3. The apparatus of claim 2 further comprising an epoxy layer within which the microlens array is embedded.

4. The apparatus of claim 1 wherein the plurality of microlenses include a dichroic coating to reflect narrowband light.

5. The apparatus of claim 4 wherein the plurality of microlenses are rotated on at least one of two axes to direct reflected light to an eyebox centered around a user viewing location.

6. The apparatus of claim 4 wherein the plurality of microlenses are rotated on two axes to direct reflected light to an eyebox centered around a user viewing location.

7. A transparent display screen comprising:
a microlens array that includes a plurality of rotated microlenses, wherein not all of the plurality of rotated microlenses are rotated by a common angle.

8. The transparent display screen of claim 7 wherein the plurality of rotated microlenses are coated with a dichroic coating to reflect narrowband light and transmit broadband light.

9. The transparent display screen of claim 7 wherein each of the plurality of rotated microlenses includes a plurality of reflective surfaces to reflect light to a plurality of user locations.

10. A windshield comprising:
an embedded microlens array that includes a plurality of individually rotated microlenses with a dichroic coating to reflect narrowband light to a driver's eye location.

11. The windshield of claim 10 wherein the microlens array is embedded in an epoxy layer.

12. The windshield of claim 11 wherein the epoxy layer is embedded between two glass layers.

13. The windshield of claim 10 wherein each of the plurality of individually rotated microlenses is rotated about at least one axis.

14. The windshield of claim 10 wherein each of the plurality of individually rotated microlenses is rotated about two axes.

15. The windshield of claim 10 wherein the dichroic coating reflects narrowband red, green, and blue light.

16. Eyewear comprising:
an eyepiece having a microlens array to reflect light to a wearer's eye, wherein the microlens array includes a plurality of individually rotated microlenses;
a projector to project an image on the microlens array, wherein the microlens array is configured to reflect the image to the wearer's eye.

17. The eyewear of claim 16 wherein each of the plurality of individually rotated microlenses is rotated on two axes.

18. The eyewear of claim 16 wherein each of the plurality of individually rotated microlenses includes a dichroic coating to reflect narrowband light and to transmit broadband light.

19. The eyewear of claim 18 wherein the projector comprises a scanning laser projector.

20. The eyewear of claim 18 wherein the dichroic coating reflects narrowband red, green, and blue light.
